(19) United States
(12) Patent Application Publication
(10) Pub. No.: US 2025/0265533 A1
(43) Pub. Date: Aug. 21, 2025

(54) METHODS AND SYSTEMS FOR FACILITATING AN ALGORITHM ACCOUNTING

(71) Applicants: Todd Marlin, Park City, UT (US); Marisa Marlin, Park City, UT (US)

(72) Inventors: Todd Marlin, Park City, UT (US); Marisa Marlin, Park City, UT (US)

(21) Appl. No.: 19/055,270

(22) Filed: Feb. 17, 2025

Related U.S. Application Data
(60) Provisional application No. 63/554,801, filed on Feb. 16, 2024.

(51) Int. Cl. G06Q 10/067

(52) U.S. Cl. CPC G06Q 10/067

(57) ABSTRACT

The present disclosure provides a method for facilitating an algorithm accounting. Further, the method may include receiving, using a communication device, an algorithm data from a user device. Further, the user device may be associated with a user. Further, the user may be associated with an organization. Further, the method may include analyzing, using a processing device, the algorithm data. Further, the algorithm data includes each of an algorithmic data corresponding to an algorithm and an organization data corresponding to the organization. Further, the algorithm may be utilized by the organization. Further, the method may include generating, using the processing device, an algorithm report data based on the analyzing. Further, the algorithm report data corresponds to a report of the algorithm. Further, the method may include transmitting, using the communication device, the algorithm report data to the user device.

### REFERENCE TO RELATED APPLICATIONS

The current application claims a priority to the U.S. provisional patent application Ser. No. 63/554,801 filed on Feb. 16, 2024, which is incorporated by reference herein in its entirety.

### FIELD OF THE INVENTION

The present disclosure generally relates to a field of data processing. More specifically, the present invention is a method and system for facilitating an algorithm accounting.

### BACKGROUND OF THE INVENTION

Management and stakeholder reporting are critical components of organizational governance and transparency, ensuring that key stakeholders are informed about the performance, progress, and decisions of the organizations. Currently, the organizations are relying on manual tracking and some software tools for reporting process. Existing solutions are not comprehensive and lack integration with other management system. The existing solution can lead to data inaccuracies, manual error, limited visibility across the organization and poor compliance with industry standards.

Therefore, there is a need for a method and system for facilitating algorithm accounting that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a method for facilitating an algorithm accounting. Further, the method may include receiving, using a communication device, an algorithm data from a user device. Further, the user device may be associated with a user. Further, the user may be associated with an organization. Further, the method may include analyzing, using a processing device, the algorithm data. Further, the algorithm data includes each of an algorithmic data corresponding to an algorithm and an organization data corresponding to the organization. Further, the algorithm may be utilized by the organization. Further, the method may include generating, using the processing device, an algorithm report data based on the analyzing. Further, the algorithm report data corresponds to a report of the algorithm. Further, the method may include transmitting, using the communication device, the algorithm report data to the user device.

The present disclosure provides a system for facilitating an algorithm accounting. Further, the system may include a communication device. Further, the communication device may be configured for receiving an algorithm data from a user device. Further, the user device may be associated with a user. Further, the user may be associated with an organization. Further, the communication device may be configured for transmitting an algorithm report data to the user device. Further, the system may include a processing device. Further, the processing device may be configured for analyzing the algorithm data. Further, the algorithm data includes each of an algorithmic data corresponding to an algorithm and an organization data corresponding to the organization. Further, the algorithm may be utilized by the organization. Further, the processing device may be configured for generating the algorithm report data based on the analyzing. Further, the algorithm report data corresponds to a report of the algorithm.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 illustrates a flowchart of a method 300 for facilitating an algorithm accounting, in accordance with some embodiments.

FIG. 4 illustrates a block diagram of a system 400 for facilitating an algorithm accounting, in accordance with some embodiments.

FIG. 5A illustrates a flowchart of a method 500 facilitating algorithm accounting, in accordance with some embodiments.

FIG. 5B illustrates a continuation of FIG. 5A.

FIG. 6 illustrates a flowchart of method 600 facilitating algorithm accounting, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g., a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g., Windows, Mac OS, Unix, Linux, Android, etc.) in order to provide a user interface (e.g., GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g., username, password, passphrase, PIN, secret question, secret answer, etc.) and/or possession of a machine readable secret data (e.g., encryption key, decryption key, bar codes, etc.) and/or or possession of one or more embodied characteristics unique to the user (e.g., biometric variables such as, but not limited to, fingerprint, palm-print, voice characteristics, behavioral characteristics, facial features, iris pattern, heart rate variability, evoked potentials, brain waves, and so on) and/or possession of a unique device (e.g., a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g., transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g., the server computer, a client device, etc.) corresponding to the performance of the one or more steps, environmental variables (e.g., temperature, humidity, pressure, wind speed, lighting, sound, etc.) associated with a device corresponding to the performance of the one or more steps, physical state and/or physiological state and/or psychological state of the user, physical state (e.g., motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g., a real-time clock), a location sensor (e.g., a GPS receiver, a GLONASS receiver, an indoor location sensor, etc.), a biometric sensor (e.g., a fingerprint sensor), an environmental variable sensor (e.g., temperature sensor, humidity sensor, pressure sensor, etc.) and a device state sensor (e.g., a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g., initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data there between corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

Management and stakeholder reporting are critical components of organizational governance and transparency, ensuring that key stakeholders are informed about the performance, progress, and decisions of the organization. Management reporting involves the regular dissemination of internal operational data, financial metrics, and performance indicators to senior management and decision-makers within the organization. These reports provide insights into areas such as sales performance, production efficiency, budgetary spending, and strategic initiatives, enabling management to make informed decisions and steer the organization effectively.

Stakeholder reporting, on the other hand, involves communicating relevant information to external parties who have a vested interest in the organization, such as shareholders, investors, regulators, customers, suppliers, and the community at large. Stakeholder reports typically include financial statements, operational updates, sustainability initiatives, corporate governance practices, and other pertinent information that helps stakeholders assess the organization's performance, risks, and impact on various stakeholders. Effective stakeholder reporting fosters trust, accountability, and transparency, enhancing the organization's reputation and stakeholder relationships.

Both management and stakeholder reporting processes involve gathering, analyzing, and presenting data in a clear, concise, and meaningful manner. They rely on accurate and timely information, supported by robust data management systems and reporting tools. Additionally, these processes may be subject to regulatory requirements and industry standards, necessitating compliance and adherence to reporting guidelines.

Overall, management and stakeholder reporting play crucial roles in facilitating informed decision-making, fostering accountability, and building trust and confidence among internal and external stakeholders. By providing transparency and insight into organizational performance and governance practices, these reporting processes contribute to the long-term sustainability and success of the organization.

The present disclosure relates to a system and a method to help users to perform algorithmic reporting. The methods and systems tracks and accounts for algorithms used with an organization. Further, the methods and systems ensure every algorithm being utilized within an organization or business is properly accounted for. It records all the money and areas an algorithm directly or indirectly touches. In order to accomplish this the systems comprises a monetary tracking system. Further, the affected parties tracking system shows which internal or external parties are affected by the algorithm. Additionally, a category tracking system shows which type of algorithm each algorithm is associated with. Further, the data tracking system displays which regulation and sensitive data are associated with the algorithm.

An objective of the present disclosure is to provide users with a system that assesses potential exposure related to each algorithm being used within each organization. Further, the method and system can determine which worldwide regulations apply to each algorithm within a system.

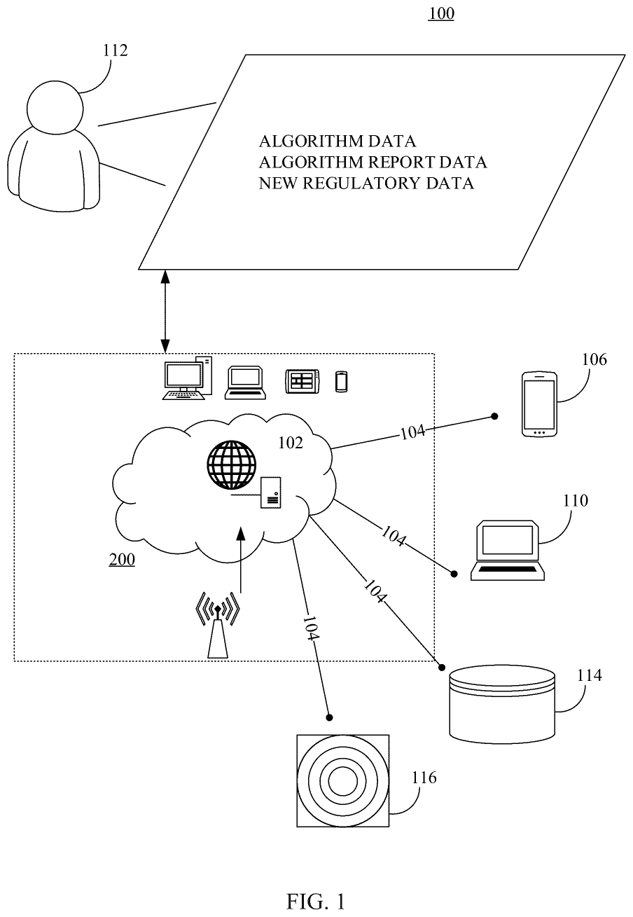

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

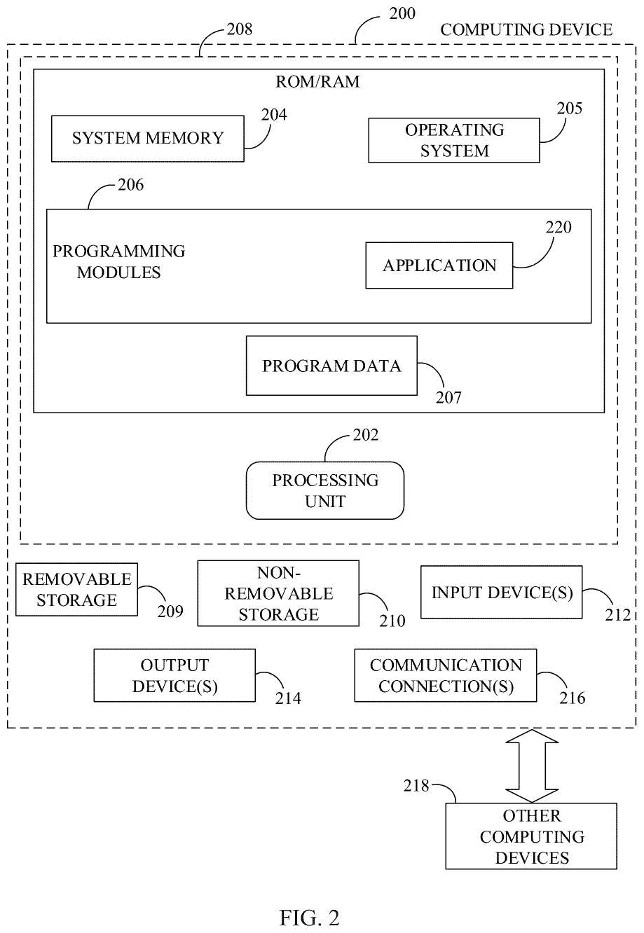

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g., random-access memory (RAM)), non-volatile (e.g., read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

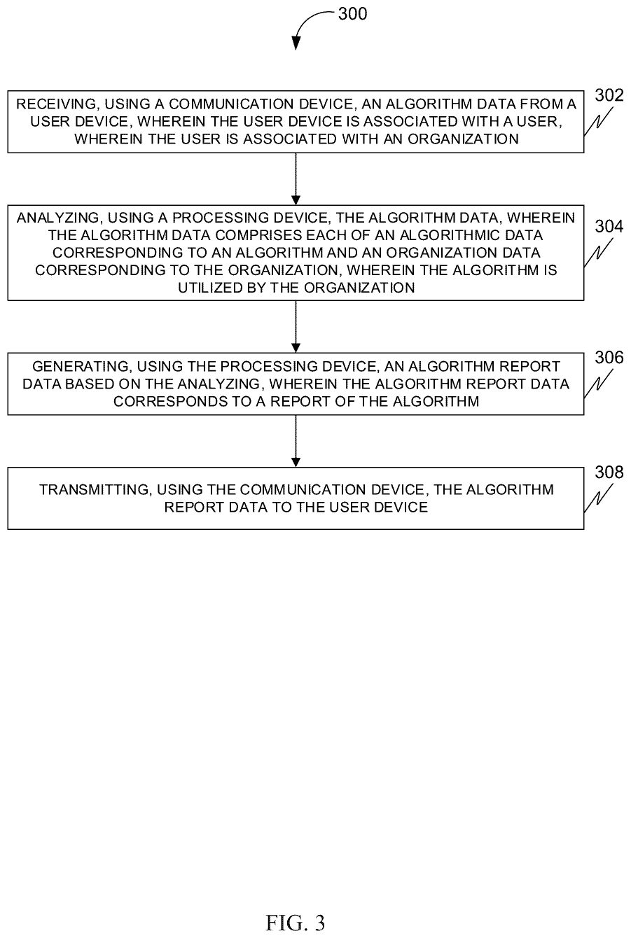

FIG. 3 illustrates a flowchart of a method 300 for facilitating an algorithm accounting, in accordance with some embodiments.

Accordingly, the method 300 may include a step 302 of receiving, using a communication device 402, an algorithm data from a user device. Further, the user device may be associated with a user. Further, the user may be associated with an organization. Further, the method 300 may include a step 304 of analyzing, using a processing device 404, the algorithm data. Further, the algorithm data includes each of an algorithmic data corresponding to an algorithm and an organization data corresponding to the organization. Further, the algorithm may be utilized by the organization. Further, the method 300 may include a step 306 of generating, using the processing device 404, an algorithm report data based on the analyzing. Further, the algorithm report data corresponds to a report of the algorithm. Further, the method 300 may include a step 308 of transmitting, using the communication device 402, the algorithm report data to the user device.

In some embodiments, the algorithm may be utilized to perform a task associated with a transaction. Further, the analyzing of the algorithm data includes identifying a transaction data. Further, the transaction data corresponds to the transaction. Further, the algorithmic data includes the transaction data.

In some embodiments, the analyzing of the algorithm data further includes identifying an algorithm output data. Further, the algorithm output data corresponds to an output delivered by the algorithm. Further, the algorithmic data further includes an algorithm output data.

In some embodiments, the task corresponds to a decision making process. Further, the algorithm output data corresponds to a decision.

In some embodiments, the algorithm belongs to one or more of a two or more algorithm categories.

In some embodiments, the two or more algorithm categories include a search algorithm category, a sorting algorithm category, a graph algorithm category, a dynamic programming algorithm category, a greedy algorithm category, a backtracking algorithm category and a heuristic algorithm category.

In some embodiments, the method 300 may further include identifying, using the processing device 404, a regulatory data based on the analyzing. Further, the regulatory data corresponds to a regulatory requirement. Further, the algorithm may be associated with the regulatory requirement. Further, the generating of the algorithm report data may be further based on the regulatory data.

In some embodiments, the algorithm report data corresponds a risk associated with the algorithm. Further, the algorithm report data further represents a department associated with the risk. Further, the organization includes two or more departments. Further, the organization data represents the two or more departments.

In some embodiments, the algorithm report data includes an insight for a decision making process. Further, the organization may be associated with the decision making process.

In some embodiments, the method 300 may further include receiving, using the communication device 402, a new regulatory data from the user device. Further, the new regulatory data corresponds to a new regulatory requirement. Further, the generating of the algorithm report data may be further based on the new regulatory data.

In some embodiments, the report represents a level of compliance of the algorithm with the new regulatory requirement.

In some embodiments, the generating may be further based on a machine learning model.

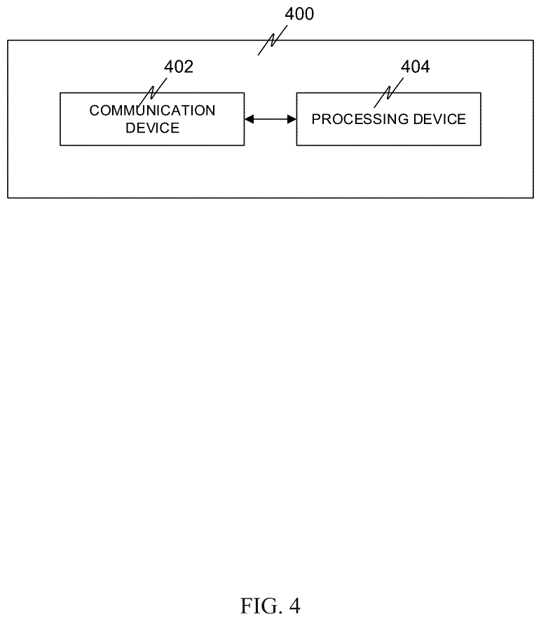

FIG. 4 illustrates a block diagram of a system 400 for facilitating an algorithm accounting, in accordance with some embodiments.

Accordingly, the system 400 may include a communication device 402. Further, the communication device 402 may be configured for receiving an algorithm data from a user device. Further, the user device may be associated with a user. Further, the user may be associated with an organization. Further, the communication device 402 may be configured for transmitting an algorithm report data to the user device. Further, the system 400 may include a processing device 404. Further, the processing device 404 may be configured for analyzing the algorithm data. Further, the algorithm data includes each of an algorithmic data corresponding to an algorithm and an organization data corresponding to the organization. Further, the algorithm may be utilized by the organization. Further, the processing device 404 may be configured for generating the algorithm report data based on the analyzing. Further, the algorithm report data corresponds to a report of the algorithm.

In some embodiments, the algorithm may be utilized to perform a task associated with a transaction. Further, the analyzing of the algorithm data includes identifying a transaction data. Further, the transaction data corresponds to the transaction. Further, the algorithmic data includes the transaction data.

In some embodiments, the analyzing of the algorithm data further includes identifying an algorithm output data. Further, the algorithm output data corresponds to an output delivered by the algorithm. Further, the algorithmic data further includes an algorithm output data.

In some embodiments, the task corresponds to a decision making process. Further, the algorithm output data corresponds to a decision.

In some embodiments, the processing device 404 may be further configured for identifying a regulatory data based on the analyzing. Further, the regulatory data corresponds to a regulatory requirement. Further, the algorithm may be associated with the regulatory requirement. Further, the generating of the algorithm report data may be further based on the regulatory data.

In some embodiments, the algorithm report data corresponds a risk associated with the algorithm. Further, the algorithm report data further represents a department associated with the risk. Further, the organization includes two or more departments. Further, the organization data represents the two or more departments.

In some embodiments, the algorithm report data includes an insight for a decision making process. Further, the organization may be associated with the decision making process.

In some embodiments, the communication device 402 may be further configured for receiving the new regulatory data from the user device. Further, the new regulatory data corresponds to a new regulatory requirement. Further, the generating of the algorithm report data may be further based on the new regulatory data.

In some embodiments, the report represents a level of compliance of the algorithm with the new regulatory requirement.

In some embodiments, the generating may be further based on a machine learning model.

In some embodiments, the algorithm report data corresponds to a management report of the organization.

In some embodiments, the algorithm report data corresponds to a stakeholder report of the organization.

In some embodiments, the algorithm may be utilized by the organization to a perform a task. Further, the algorithm report data corresponds to a performance of the task.

In some embodiments, the algorithm report data includes a metric representing the performance of the task.

In some embodiments, the organization data corresponds to two or more departments associated with the organization.

In some embodiments, the algorithm report data includes one or more of an audio data, a text data and a video data.

In some embodiments, the algorithm report data corresponds to an evaluation report representing an accuracy of a completion of the task.

In some embodiments, the transaction data represent a money value associated with the transaction.

In some embodiments, the algorithm may be associated with two or more tasks. Further, the analyzing further includes identifying a count of the two or more tasks. Further, the algorithm report data corresponds to the record of two or more money values and two or more algorithm output data. Further, the two or more tasks may be associated with the two or more money values. Further, the two or more algorithm output data corresponds to two or more outputs delivered by the algorithm for the two or more tasks.

In some embodiments, the two or more tasks corresponds to a decision making process. Further, the two or more algorithm output data corresponds to two or more decisions.

In some embodiments, the transaction may data represents a type of the transaction.

In some embodiments, the regulation data corresponds to one or more of a law and a guideline. Further, a task performed by the algorithm may be based on one or more of the law and the guideline.

In some embodiments, the organization may be further based on one or more of the law and the guideline.

In some embodiments, the regulatory data corresponds to a worldwide regulation.

In some embodiments, the algorithm report data represents a compliance of the algorithm with the regulatory requirement.

In some embodiments, the two or more departments includes each of an internal department and an external department. Further, the department belongs to one or more of the internal department and the external department.

In some embodiments, the algorithm includes two or more algorithms. Further, the regulatory data includes two or more regulatory data. Further, the two or more regulatory data corresponds to the two or more regulatory requirements corresponding to the two or more algorithms.

In some embodiments, the algorithm data includes a first algorithm data and a second algorithm data corresponding to a first algorithm and a second algorithm respectively. Further, the two or more algorithms includes the first algorithm and the second algorithm. Further, the two or more regulatory data includes a first regulation data and a second regulation data corresponding to the first algorithm and the second algorithm respectively. Further, the first regulation data and the second regulation data may be based on a first regulatory requirement and a second regulatory requirement respectively. Further, the first regulatory requirement may be different from the second regulatory requirement. Further, the two or more regulatory requirements includes the first regulatory requirement and the second regulatory requirement.

In some embodiments, the organization belongs to a financial department.

In some embodiments, the organization corresponds to a bank.

In some embodiments, the record corresponds to two or more transactions. Further, the algorithm completed the task based on the two or more transactions.

In some embodiments, the record corresponds to two or more transactions. Further, the algorithm completed two or more tasks based on the two or more transactions.

In some embodiments, the analyzing of the algorithm data includes identifying a category. Further, the algorithm belongs to the category. Further, the algorithm data represent the category.

In some embodiments, the organization belongs to the financial department. Further, the category corresponds to one or more of a loan decision, a hiring decision, a fraud detection, a customer segmentation, an inventory optimization and a compliance monitoring.

In some embodiments, the algorithm corresponds to a task. Further, the analyzing of the algorithmic data includes identifying a confidential data. Further, the task may be based the confidential data.

In some embodiments, the task corresponds to processing a loan. Further, the confidential data corresponds to a personal detail of a customer. Further, the loan belongs to the customer.

In some embodiments, the personal detail corresponds to one or more of a customer identity, a customer personal preference, a gender of the customer, a location of the customer, an income bracket of the customer, an ethnicity of the customer, a social security number of the customer, a credit history of the customer and a debt history of the customer.

In some embodiments, the algorithm includes two or more algorithms. Further, the algorithm report data represents a level of compliance of the two or more algorithms with the new regulatory requirement.

In some embodiments, the new regulatory data includes two or more new regulatory data corresponding to two or more new regulatory requirements.

In some embodiments, the analyzing further includes identifying one of the two or more new regulatory requirements for one of the two or more algorithms. Further, the one of the two or more new regulatory requirements corresponds to one of the two or more algorithms.

In some embodiments, the internal departments include one or more of a sales department and an accounting department.

In some embodiments, the external departments correspond to one or more of an investor of the organization, a competitor of the organization, a supplier associated with the organization, a vendor associated with the organization and a customer of the organization.

In some embodiments, the new regulatory requirement corresponds to a data protection compliance.

In some embodiments, the new regulatory requirement corresponds to a fair credit reporting act compliance.

In some embodiments, the method 300 may further include storing, using the processing device 404, the algorithm report data in a database. Further, the database includes two or more algorithm report data.

In some embodiments, the two or more algorithm report data corresponds to two or more algorithms.

In some embodiments, the two or more algorithm report data corresponds to the algorithm. Further, the two or more algorithm report data includes a first algorithm report data and second algorithm report data stored at a first time instance and a second time instance respectively.

In some embodiments, the algorithm result data represents a count of two or more models associated with the algorithm.

In some embodiments, the algorithm result data represent an impact of the algorithm in the organization.

In some embodiments, the algorithm result data represent to one or more of a quantitative impact and a qualitative impact of the algorithm in the organization.

In some embodiments, the algorithm result data represents a money value associated with a task in one or more of a direct way and an indirect way. Further, the algorithm may be utilized to complete the task.

In some embodiments, the algorithm result data represents a department. Further, the algorithm may be associated with the department in one or more of a direct way and an indirect way. Further, the two or more departments includes the department.

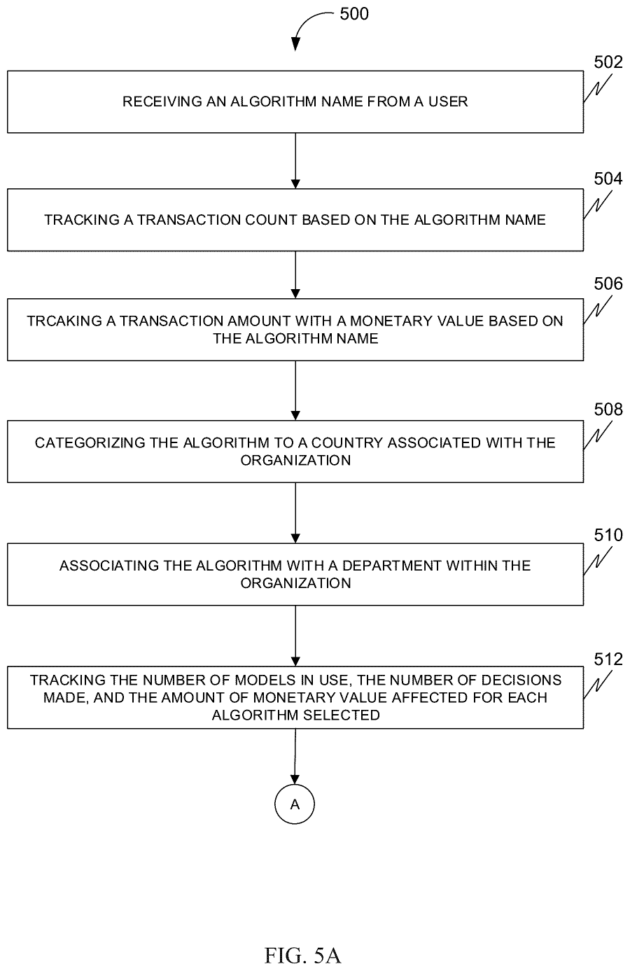

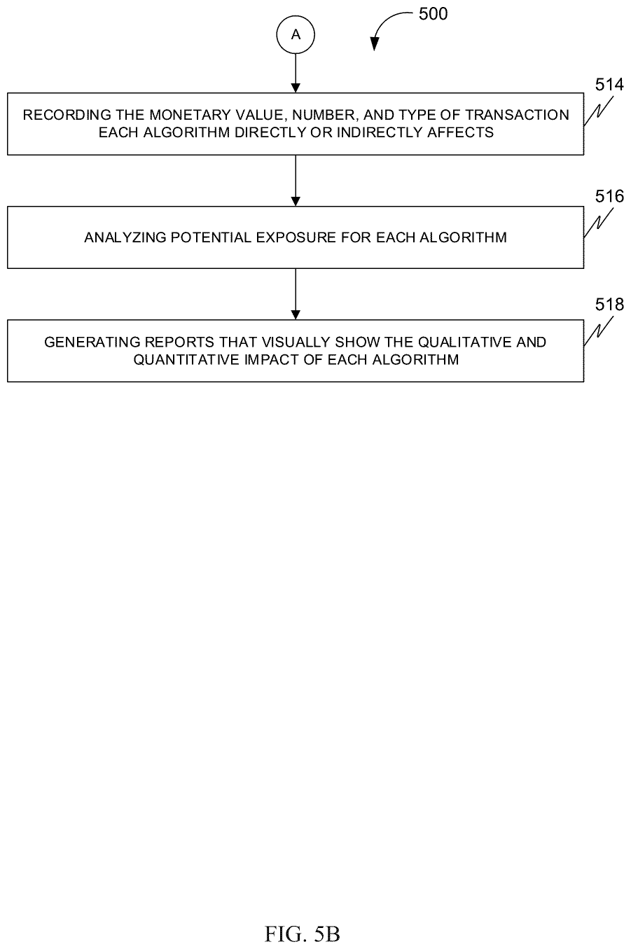

FIG. 5A and FIG. 5B illustrate a flowchart of a method 500 facilitating algorithm accounting, in accordance with some embodiments.

Further, the method 500 may include a step 502 of receiving an algorithm name from a user. Further, the algorithm name may include an algorithm type such as loan decision, hiring decision, customer segmentation, fraud detection, inventory optimization, and compliance monitoring. Further, the method 500 may include a step 504 of tracking a transaction count based on the algorithm name. Further, the method 500 may include a step 506 of tracking a transaction amount with a monetary value based on the algorithm name. Further, the algorithm name may track the transaction amount with a monetary value such as dollars.

Further, the method 500 may include a step 508 of categorizing the algorithm to a country associated with the organization. Further, the method 500 may include a step 510 of associating a department with the algorithm. Further, the department may include but is not limited to accounting, sales, etc. Further, the method 500 may include a step 512 of tracking the number of models in use, the number of decisions made, and the amount of monetary value affected for each algorithm selected. The present invention is designed to account for every algorithm that is use within an organization. Further, the method 500 may include a step 514 of recording the monetary value, number, and type of transactions that the algorithm directly or indirectly affects. Furthermore, if the algorithm does not directly or indirectly affect a monetary value the method enables the controlling organization to identify the number and frequency of different potential affected stakeholders related to an algorithm. For example, the affected stakeholders or parties may include but are not limited to employees, investors, competitors, suppliers, vendors, customers, etc. The method of the present invention determines which regulations each algorithm is associated with and subject to worldwide through an analyzation with a language model. Further, the method 500 may include a step 516 of analyzing potential exposure related to each algorithm if decisions or transactions are wrong. Further, the method 500 may include a step 518 of generating reports that are similar to financial statements to visualize the qualitative and quantitative impact of each algorithm selected.

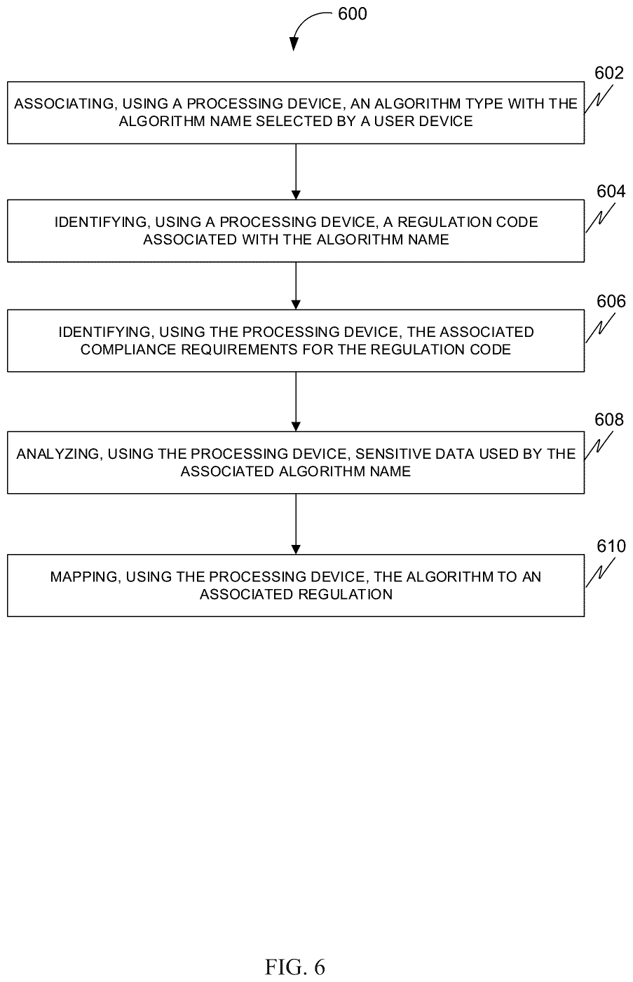

FIG. 6 illustrates a flowchart of method 600 facilitating algorithm accounting, in accordance with some embodiments.

Further, the method 600 may include a step 602 of associating, using a processing device, an algorithm type with the algorithm name selected by a user device. Further, the at least one user device may include, but may not be limited to, a smartphone, a laptop, a desktop, a tablet computer, etc.

Further, the method 600 may include a step 604 of identifying, using a processing device, a regulation code associated with the algorithm name.

Further, the method 600 may include a step 606 of identifying, using the processing device, the associated compliance requirements for the regulation code. Further the compliance requirements may include but are not limited to non-discrimination towards protected groups, decision transparency and explainability, diversity and inclusion requirements, privacy and data protection compliance, fair credit reporting act compliance. Further, the method 600 may include a step 608 of analyzing, using the processing device, sensitive data used by the associated algorithm name.

Further, the sensitive data by include, but may not be limited to, a location, a gender, an ethnicity, an income bracket, a customer ID, a purchase history, a personal preference, a social security number, a credit history, a debt information, etc.

Further, the method acquires new regulatory profiles to create impact assessments for each algorithm. This design allows for management to see which algorithms are the most valuable, and check each algorithm being used by the organization on a periodic basis. Further, the method 600 may include a step 610 of mapping the algorithms to appropriate regulations to help management to understand various liabilities and see who is directly affected by each algorithm.

Although the invention has been explained in relation to its preferred embodiment, it is to be understood that many other possible modifications and variations can be made without departing from the spirit and scope of the invention as hereinafter claimed.

What is claimed is:

1. A method for facilitating an algorithm accounting, the method comprising:
receiving, using a communication device, an algorithm data from a user device, wherein the user device is associated with a user, wherein the user is associated with an organization;
analyzing, using a processing device, the algorithm data, wherein the algorithm data comprises each of an algorithmic data corresponding to an algorithm and an organization data corresponding to the organization, wherein the algorithm is utilized by the organization;
generating, using the processing device, an algorithm report data based on the analyzing, wherein the algorithm report data corresponds to a report of the algorithm; and
transmitting, using the communication device, the algorithm report data to the user device.

2. The method of claim 1, wherein the algorithm is utilized to perform a task associated with a transaction, wherein the analyzing of the algorithm data comprises identifying a transaction data, wherein the transaction data corresponds to the transaction, wherein the algorithmic data comprises the transaction data.

3. The method of claim 2, wherein the analyzing of the algorithm data further comprises identifying an algorithm output data, wherein the algorithm output data corresponds to an output delivered by the algorithm, wherein the algorithmic data further comprises an algorithm output data.

4. The method of claim 3, wherein the task corresponds to a decision making process, wherein the algorithm output data corresponds to a decision.

5. The method of claim 1 further comprises identifying, using the processing device, a regulatory data based on the analyzing, wherein the regulatory data corresponds to a regulatory requirement, wherein the algorithm is associated with the regulatory requirement, wherein the generating of the algorithm report data is further based on the regulatory data.

6. The method of claim 5, wherein the algorithm report data corresponds a risk associated with the algorithm, wherein the algorithm report data further represents a department associated with the risk, wherein the organization comprises a plurality of departments, wherein the organization data represents the plurality of departments.

7. The method of claim 1, wherein the algorithm report data comprises an insight for a decision making process, wherein the organization is associated with the decision making process.

8. The method of claim 1 further comprises receiving, using the communication device, a new regulatory data from the user device, wherein the new regulatory data corresponds to a new regulatory requirement, wherein the generating of the algorithm report data is further based on the new regulatory data.

9. The method of claim 8, wherein the report represents a level of compliance of the algorithm with the new regulatory requirement.

10. The method of claim 1, wherein the generating is further based on a machine learning model.

11. A system for facilitating an algorithm accounting, the system comprising:
a communication device configured for:
receiving an algorithm data from a user device, wherein the user device is associated with a user, wherein the user is associated with an organization; and
transmitting an algorithm report data to the user device;
a processing device configured for:
analyzing the algorithm data, wherein the algorithm data comprises each of an algorithmic data corresponding to an algorithm and an organization data corresponding to the organization, wherein the algorithm is utilized by the organization; and
generating the algorithm report data based on the analyzing, wherein the algorithm report data corresponds to a report of the algorithm.

12. The system of claim 11, wherein the algorithm is utilized to perform a task associated with a transaction, wherein the analyzing of the algorithm data comprises identifying a transaction data, wherein the transaction data corresponds to the transaction, wherein the algorithmic data comprises the transaction data.

13. The system of claim 12, wherein the analyzing of the algorithm data further comprises identifying an algorithm output data, wherein the algorithm output data corresponds to an output delivered by the algorithm, wherein the algorithmic data further comprises an algorithm output data.

14. The system of claim 13, wherein the task corresponds to a decision making process, wherein the algorithm output data corresponds to a decision.

15. The system of claim 11, wherein the processing device is further configured for identifying a regulatory data based on the analyzing, wherein the regulatory data corresponds to a regulatory requirement, wherein the algorithm is associated with the regulatory requirement, wherein the generating of the algorithm report data is further based on the regulatory data.

16. The system of claim 15, wherein the algorithm report data corresponds a risk associated with the algorithm, wherein the algorithm report data further represents a department associated with the risk, wherein the organization comprises a plurality of departments, wherein the organization data represents the plurality of departments.

17. The system of claim 11, wherein the algorithm report data comprises an insight for a decision making process, wherein the organization is associated with the decision making process.

18. The system of claim 11, wherein the communication device is further configured for receiving the new regulatory data from the user device, wherein the new regulatory data corresponds to a new regulatory requirement, wherein the generating of the algorithm report data is further based on the new regulatory data.

19. The system of claim 18, wherein the report represents a level of compliance of the algorithm with the new regulatory requirement.

20. The system of claim 1, wherein the generating is further based on a machine learning model.
